(19) United States
(12) Patent Application Publication
(10) Pub. No.: US 2020/0048860 A1
(43) Pub. Date: Feb. 13, 2020

(54) Attachment Coupling Link For Excavator

(71) Applicant: Jung Su JANG, Gyeonggi-do (KR)

(72) Inventor: Jung Su JANG, Gyeonggi-do (KR)

(21) Appl. No.: 16/165,095

(22) Filed: Oct. 19, 2018

(30) Foreign Application Priority Data
Aug. 9, 2018 (KR) 10-2018-0092808

(51) Int. Cl. E02F 3/36; F15B 15/06

(52) U.S. Cl. CPC E02F 3/3618; F15B 15/06; E02F 3/3622; E02F 3/3663

(57) ABSTRACT

There is provided an attachment coupling link, including: a cover having a pair of boom link coupling shafts coupled thereto in parallel with each other; a fixing hook fixedly coupled to a lower end of one side of the cover to have a first connection bar of an attachment removably coupled thereto; a pivoting hook coupled to a lower end of the other side of the cover to be pivotable about a pivoting hook pivoting shaft, a second connection bar of the attachment being removably coupled to the pivoting hook; a connection bar release prevention lever pivotably coupled to an upper end of the fixing hook; and an operating cylinder disposed between the fixing hook and the pivoting hook, the operating cylinder allowing the second connection bar to be mounted in or dismounted from the pivoting hook by adjusting a pivoting angle of the pivoting hook.

### CROSS-REFERENCE TO RELATED PATENT APPLICATION

This application claims the benefits of and priority to Korean Patent Application No. 10-2018-0092808, filed on Aug. 9, 2018 in the Korean Intellectual Property Office, the disclosure of which is incorporated herein by reference in its entirety.

### FIELD

The present disclosure relates to an attachment coupling link for an excavator, and more particularly, to an attachment coupling link for an excavator, which can safely use and replace an attachment without a safety pin.

### BACKGROUND

In general, an excavator, called “Poclain” is an equipment used to remove rocks or soils from the ground at the initial stage of a foundation work for construction.

An excavator includes an arm consisting of a plurality of joints, and has a boom cylinder provided in the arm and connected by means of a bucket link, and a bucket installed at the bucket link to dig rocks or soils. The excavator supplies a hydraulic pressure to the boom cylinder through a hydraulic line, scoops up soils, etc., using the bucket, pivots, and then loads or stacks soils on a dump truck.

In addition, various attachments, such as a breaker for breaking rocks or concrete into small pieces or a shear for cutting a steel plate, a rebar, or an H-beam, may be selectively mounted on the bucket link at the end of the arm of the excavator instead of the bucket, and the excavator can perform a work according to a condition of a work site.

FIG. 1 is a view illustrating an example of a process of replacing an attachment 20 in a related-art excavator 10. As shown in FIG. 1, a pair of connection bars 21, 23 are disposed on an upper portion of the attachment 20, and a bucket link 30 coupled to an end of an arm 11 is provided with a fixing hook 31 and a pivoting hook 33. The first connection bar 21 is inserted into the fixing hook 31, and the second connection bar 23 is inserted into the pivoting hook 33.

FIG. 2 is a side view illustrating the configuration of the related-art bucket link 30. As shown in FIG. 2, the bucket link 30 is provided with an operating cylinder 35 for adjusting a pivoting angle of the pivoting hook 33. The pivoting angle of the pivoting hook 33 is adjusted according to a change in the length of a rod 35a of the operating cylinder 35, and the pivoting hook 33 is coupled to or decoupled from the second connection bar 23.

However, the pivoting hook 33 may pivot in an undesired direction due to a vibration generated when the excavator 10 is used or malfunction of the operating cylinder 35, and thus the second connection bar 23 may be frequently decoupled from the pivoting hook 33.

When the second connection bar 23 is decoupled from the pivoting hook 33, the attachment 20 may drop down, causing a safety accident.

To prevent the safety accident, the related-art bucket link 30 employs a safety pin 37 for maintaining a secure coupling state between the bucket link 30 and the attachment 20.

A wedge 33a protrudes from an upper portion of the pivoting hook 33, and the safety pin 37 is disposed within a pivoting radius of the wedge 33a. The safety pin 37 comes into contact with the wedge 33a to prevent the pivoting hook 33 from pivoting further.

Since the wedge 33a comes into contact with the safety pin 37 and refrains from pivoting further, the coupling state between the pivoting hook 33 and the second connection bar 23 is stably maintained, and a safe work can be performed.

However, to place the attachment 20, an operator is required to get out of a driver's seat and to manually pull the safety pin 37 out and couple another attachment. In addition, since the safety pin 37 is separately stored, there is a problem that the safety pin 37 is lost.

To this end, many excavator operators may drive excavators without fastening safety pins due to the inconvenience of having to coupling safety pins every time and decoupling the safety pins to place attachments. Therefore, since safety accidents such as attachment (or bucket) drop accidents frequently occur, the function of the safety pin is not properly performed.

### SUMMARY

The present disclosure has been developed to solve the above-described problems, and an objective of the present disclosure is to provide an attachment coupling link for an excavator, which can stably couple a pair of connection bars and a fixing hook and a pivoting hook without using a safety pin.

Another objective of the present disclosure is to provide an attachment coupling link for an excavator, which can prevent a first connection bar from being released from a fixing hook as long as a hydraulic pressure is applied to drive the attachment.

Still another objective of the present disclosure is to provide an attachment coupling link for an excavator, which has a pivoting hook pivoted in a direction of maintaining coupling with a second connection bar, thereby preventing the second connection bar from being released.

The above-described objectives and various advantages of the present disclosure will be more apparent to a person skilled in the art from preferred embodiments of the present disclosure.

According to an embodiment of the present disclosure, there is provided an attachment coupling link for an excavator, including: a cover having a pair of boom link coupling shafts coupled thereto in parallel with each other, the boom link coupling shafts being coupled to boom links of an excavator; a fixing hook fixedly coupled to a lower end of one side of the cover to have a first connection bar of an attachment removably coupled thereto; a pivoting hook coupled to a lower end of the other side of the cover to be pivotable about a pivoting hook pivoting shaft, a second connection bar of the attachment being removably coupled to the pivoting hook; a connection bar release prevention lever pivotably coupled to an upper end of the fixing hook; and an operating cylinder disposed between the fixing hook and the pivoting hook, the operating cylinder allowing the second connection bar to be mounted in or dismounted from the pivoting hook by adjusting a pivoting angle of the pivoting hook, the operating cylinder preventing the first connection bar from being released from the fixing hook by adjusting a distance between the connection bar release prevention lever and the fixing hook by adjusting a pivoting angle of the connection bar release prevention lever.

According to an embodiment, the operating cylinder may include: an operating cylinder body fixedly coupled to the cover between the fixing hook and the pivoting hook, and allowing an operating fluid to flow therein; and a pressing rod inserted into the operating cylinder body in a longitudinal direction, and moving between the fixing hook and the pivoting hook in both directions according an amount of the moved operating fluid.

According to an embodiment, the pivoting hook may be coupled to one end of the pressing rod by means of a pivoting hook cylinder coupling shaft, and may pivot about the pivoting hook pivoting shaft according to a change in a length of the pressing rod between the operating cylinder body and the pivoting hook cylinder coupling shaft, the second connection bar 23 being mounted on or dismounted from the pivoting hook.

According to an embodiment, the connection bar release prevention lever may include: a pair of lever bodies; a lever cylinder coupling shaft coupling the pair of lever bodies 161 and the other end of the pressing rod; and a lever pivoting shaft disposed under the lever cylinder coupling shaft to support the pair of lever bodies 161 to pivot with respect to the cover, and the pair of lever bodies may pivot about the lever pivoting shaft according to a change in the length of the pressing rod between the operating cylinder body and the lever cylinder coupling shaft, and a distance between the pair of lever bodies and the fixing hook may be adjusted.

According to an embodiment, the attachment coupling link may further include a pivoting hook elastic pressing portion disposed on an upper portion of the pivoting hook to apply an elastic force to allow the pivoting hook pivoting shaft to pivot in a direction of maintaining a coupling state between the pivoting hook and the second connection bar.

According to an embodiment, a second connection bar coupling recess may be dented on a lower portion of the pivoting hook to have the second connection bar inserted thereinto, a wedge may extend outward from an upper portion of the pivoting hook to be opposite the second connection bar coupling recess, and the pivoting hook elastic pressing portion may include: a lower elastic member coupling block coupled to the wedge; an upper elastic member coupling block spaced apart from the lower elastic member coupling block; a middle cover coupling shaft penetrating through the upper elastic member coupling block to be coupled to the cover; and an elastic member coupled between the lower elastic member coupling block and the upper elastic member coupling block to apply an elastic force to the wedge.

In the attachment coupling link according to the present disclosure, the lever bodies of the connection bar release prevention lever block the release path of the first connection bar as long as the operating cylinder applies a hydraulic pressure to maintain the coupling state between the pivoting hooks and the second connection bar, and the first connection bar is prevented from being released.

In addition, the pivoting hook elastic pressing portion is coupled to the pivoting hooks, and the elastic member applies an elastic force in the direction of maintaining a coupling state between the pivoting hooks and the second connection bar, such that the second connection bar is not released from the pivoting hooks even when the operating cylinder is not well operated. Accordingly, a safety accident can be prevented and a safe work can be performed.

In addition, the pair of connection bars and the fixing hook and the pivoting hooks can be stably coupled to each other without using a safety pin which is used in a related-art attachment coupling link for the purpose of safety.

In addition, an operator is not required to pull out a safety pin and to fasten the pin manually, and can attach and detach an attachment and replace the same simply by driving the operating cylinder.

### BRIEF DESCRIPTION OF THE DRAWINGS

The above and other features and advantages will become more apparent by describing in detail exemplary embodiments with reference to the attached drawings in which:

FIG. 1 is a view illustrating an example of a process of coupling an attachment to a related-art excavator;

FIG. 2 is a view illustrating an example of an operation of a safety pin in the related-art bucket link;

FIG. 3 is a perspective view illustrating a configuration of a coupling link according to an embodiment of the present disclosure;

FIGS. 4, 5, and 6 are views illustrating the coupling link from various directions for the purpose of understanding of the embodiment of FIG. 3;

FIGS. 7 and 8 are views illustrating the coupling link without some elements for the purpose of understanding of the embodiment of FIG. 3;

FIG. 9 is a perspective view illustrating an interior of the coupling link according to the present disclosure;

FIG. 10 is an exploded perspective view illustrating the configuration of the coupling link according to the present disclosure; and

FIGS. 11, 12A and 12B are views illustrating an operating process of the coupling link according to the present disclosure.

### DETAILED DESCRIPTION

Exemplary embodiments of the present disclosure will be described herein below with reference to the accompanying drawings for fully understanding of the present disclosure. The exemplary embodiments may, however, be embodied in many different forms and should not be construed as limited to the exemplary embodiments set forth herein. Rather, the exemplary embodiments are provided so that this disclosure will be thorough and complete, and will fully convey the scope of the application to those of ordinary skill in the art. Accordingly, in the drawings, shapes and etc. of elements may be exaggerated for easy understanding of technical features. In the drawings, the same reference numerals are used for the same elements. In the description of the exemplary embodiment, certain detailed explanations of well-known functions and constructions art are omitted when it is deemed that they may unnecessarily obscure the essence of the present disclosure.

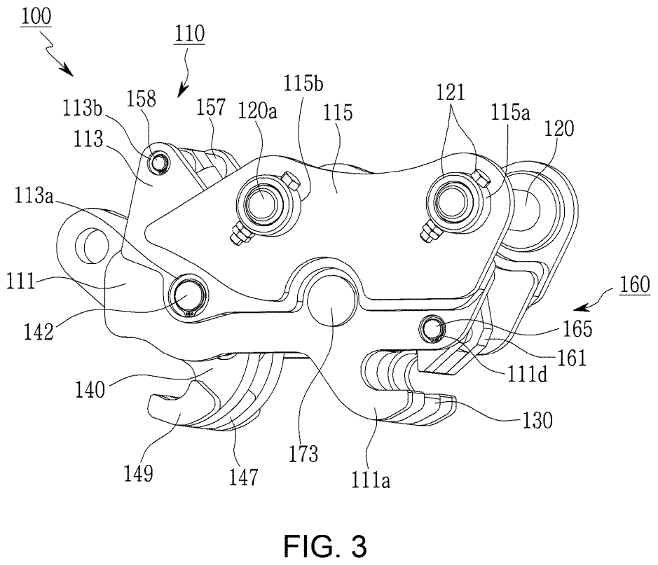

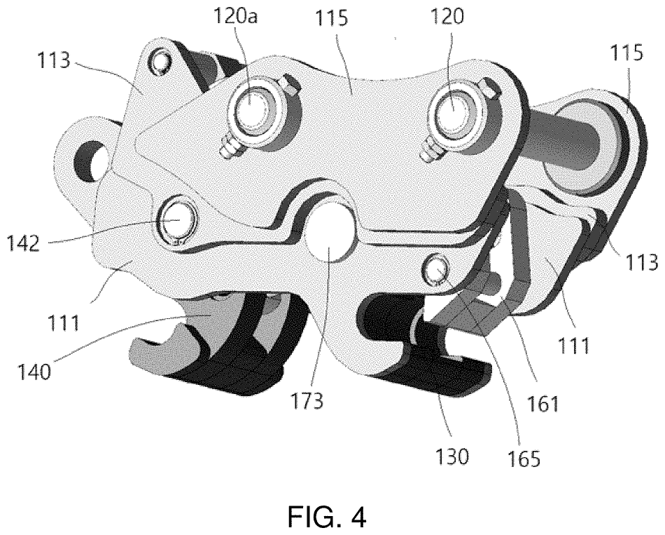

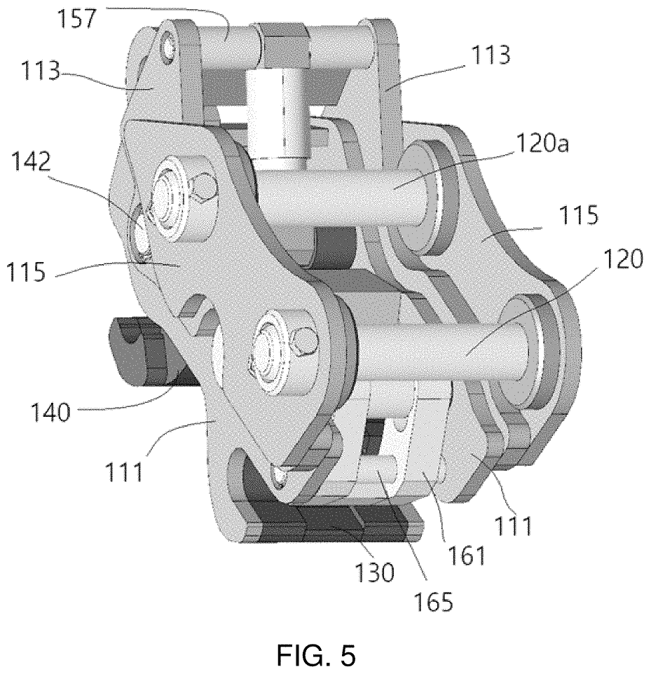

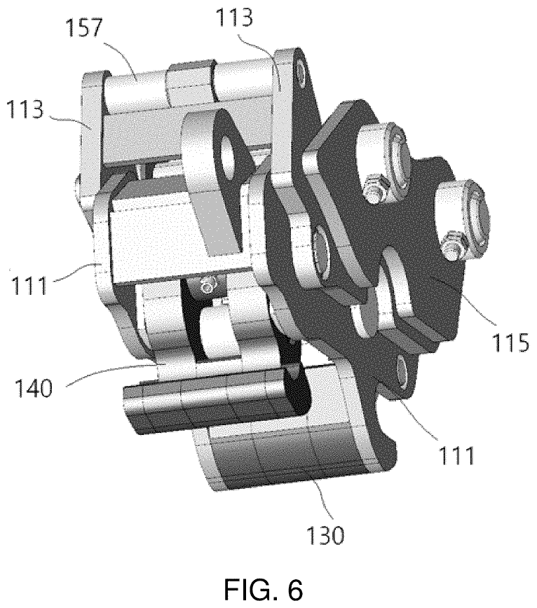

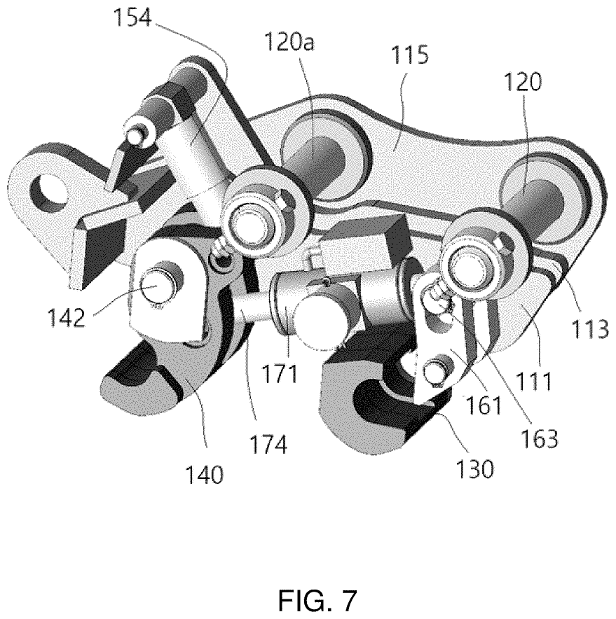

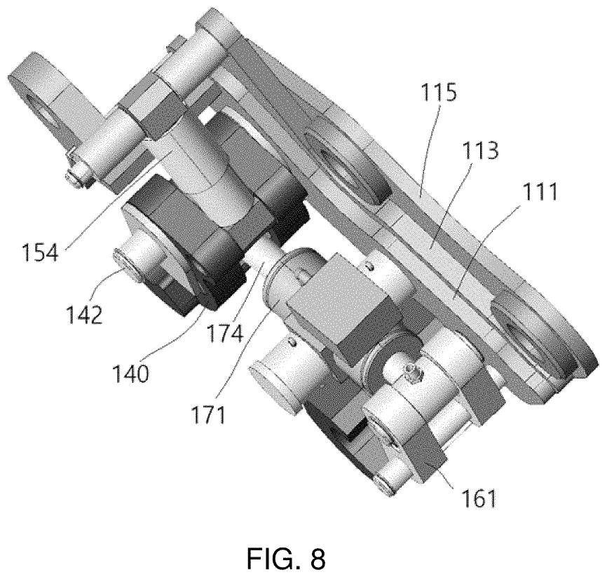

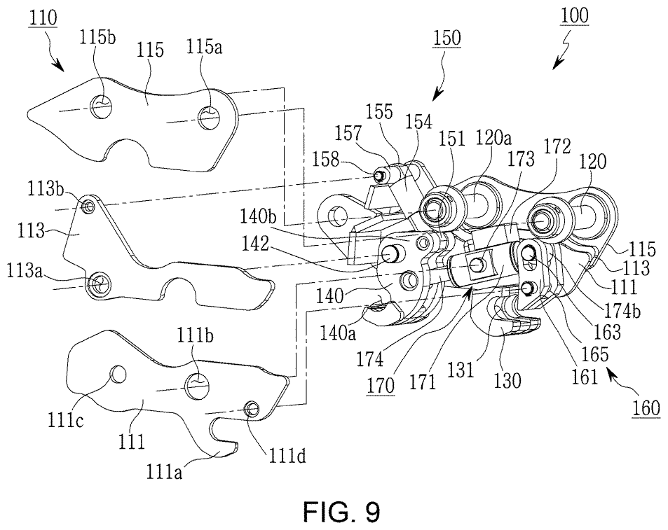

FIG. 3 is a perspective view illustrating a configuration of an attachment coupling link 100 for an excavator according to the present disclosure, FIGS. 4 to 6 are views illustrating the attachment coupling link from various directions for the purpose of understanding of the embodiment of FIG. 3, FIGS. 7 and 8 are views illustrating the attachment coupling link without some elements for the purpose of understanding of the embodiment of FIG. 3, and FIG. 9 is a perspective view illustrating the attachment coupling link with the cover 110 being separated in FIG. 3.

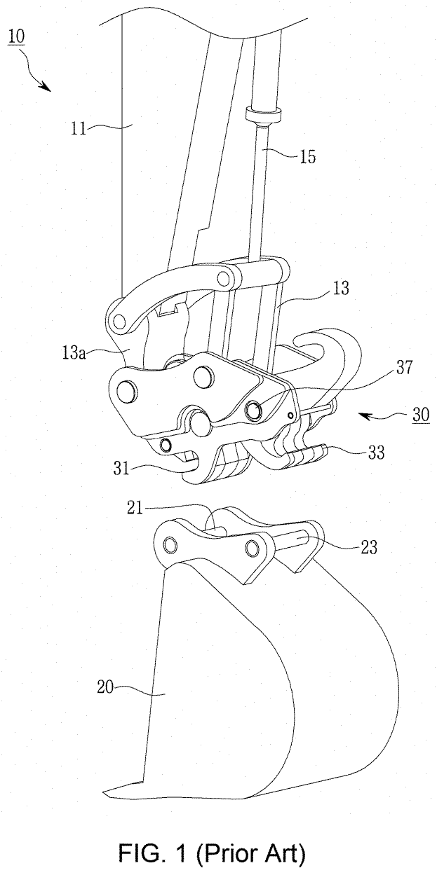

The attachment coupling link 100 according to the present disclosure is coupled to an end of the arm 11 (see FIG. 1) of the excavator 10 (see FIG. 1) to enable the attachment 20 (see FIG. 1) to be replaced with another attachment and to be used

The attachment coupling link 100 of the present disclosure includes: a cover 110 surrounding the exterior of the attachment coupling link 100; a pair of boom link coupling shafts 120, 120a coupled to upper portions of the cover 110 to be coupled with boom links 13, 13a of the excavator 10; a fixing hook 130 fixedly coupled to a lower portion of one side of the cover 110 to be coupled with the first connection bar 21 of the attachment 20; a pivoting hook 140 pivotably coupled to a lower portion of the other side of the cover 110 to be coupled with the second connection bar 23 of the attachment 20; a pivoting hook elastic pressing portion 150 coupled to the pivoting hook 140 to apply an elastic force in a direction of maintaining a coupling state between the pivoting hook 140 and the second connection bar 23; a connection bar release prevention lever 160 pivotably coupled to an upper portion of the fixing hook 130 to prevent the first connection bar 21 from being released; and an operating cylinder 170 disposed between the fixing hook 130 and the pivoting hook 140 to adjust a pivoting angle of the pivoting hook 140 and a pivoting angle of the connection bar release prevention lever 160.

The connection bar release prevention lever 160 of the attachment coupling link 100 according to the present disclosure prevents the first connection bar 21 from being released from the fixing hook 130, by adjusting a distance to the fixing hook 130 by means of the operating cylinder 170.

In addition, the pivoting hook elastic pressing portion 150 may apply an elastic force to the pivoting hook 140 to prevent the second connection bar 23 from being released from the pivoting hook 140, and to stably maintain a coupling state between the second connection bar 23 and the pivoting hook 140.

Accordingly, there is provided the attachment coupling link which can stably maintain a coupling state with the attachment without a separate safety pin, and can prevent a safety accident, and also, can easily replace the attachment.

Referring to FIGS. 3 to 9, the cover 110 supports the pair of boom link coupling shafts 120, 120a, and supports the respective elements to be smoothly operated. The cover 110 includes a pair of internal covers 111 disposed in contact with the fixing hook 130, a pair of middle covers 113 disposed on outsides of the internal covers 111, and a pair of external covers 115 disposed on outsides of the middle covers 113.

The pair of internal covers 111 are disposed on both sides of the fixing hook 130, and pivotably support the pivoting hook 140 and pivotably support the connection bar release prevention lever 160. Fixing hook covers 111a protrude from lower portions of the internal covers 111 to correspond to the shape of the fixing hook 130. A cylinder fixing shaft receiving hole 111b, a first pivoting shaft receiving hole 111c, and a lever pivoting shaft receiving hole 111d penetrate through a plate surface of each of the internal covers 111.

A cylinder body fixing shaft 173 of the operating cylinder 170 is received in the cylinder fixing shaft receiving hole 111b to protrude therefrom. Both ends of a pivoting hook pivoting shaft 142 of the pivoting hook 140 are pivotably coupled to the first pivoting shaft receiving holes 111c. A lever pivoting shaft 165 of the connection bar release prevention lever 160 is pivotably coupled to the lever pivoting shaft receiving hole 111d.

The pair of middle covers 113 are disposed on both sides of the pair of internal covers 111, and pivotably support the pivoting hook 140 and fix the pivoting hook elastic pressing portion 150. A second pivoting shaft receiving hole 113a and a middle cover coupling shaft receiving hole 113b penetrate through a plate surface of each of the middle covers 113.

The second pivoting shaft receiving hole 113a penetrate through the middle covers 113 to have the same axis as the first pivoting shaft receiving hole 111c of the internal cover 111, and both ends of the pivoting hook pivoting shaft 142 of the pivoting hook 140 are pivotably coupled to the second pivoting shaft receiving holes 113a. Both ends of the pivoting hook pivoting shaft 142 penetrate through the first pivoting shaft receiving holes 111c of the internal covers 111 and are pivotably coupled to the second pivoting shaft receiving holes 113a. Both ends of a middle cover coupling shaft 158 of the pivoting hook elastic pressing portion 150 are received in the middle cover coupling shaft receiving holes 113b.

The pair of external covers 115 support the pair of boom link coupling shafts 120, 120a. A first boom link coupling shaft receiving hole 115a and a second boom link coupling shaft receiving hole 115b, spaced apart from each other, penetrate through a plate surface of each of the pair of external covers 115. Both ends of the first boom link coupling shaft 120 are received in the first boom link coupling shaft receiving holes 115a, and both ends of the second boom link coupling shaft 120a are received in the second boom link coupling shaft receiving holes 115b.

The internal covers 111, the middle covers 113, and the external covers 115 are stacked one on another, and the internal covers 111 and the middle covers 113 are coupled to the pivoting hook pivoting shaft 142 and are fixed in their positions. The external covers 115 are disposed to surround the outsides of the middle covers 113 and then both ends of the pair of boom link coupling shafts 120, 120a are coupled to the external covers 115 and are fixed by a fastening member 121, such that the external covers 115 are fixed to the middle covers 113.

The pair of boom link coupling shafts 120, 120a are disposed between the pair of external covers 115, and are coupled with the boom links 13, 13a of the excavator 10. The boom link coupling shafts 120, 120a receive a change in the length of the boom cylinder 15 by means of the boom links 13, 13a to allow the attachment 20 to pivot.

The fixing hook 130 is fixedly coupled to the internal covers 111, and the first connection bar 21 is removably coupled to the fixing hook 130. An upper portion of the fixing hook 130 is fixed to the internal covers 111 by welding, etc. A first connection bar coupling recess 131 is dented inward from a lower portion of the fixing hook 130, and has the first connection bar 21 inserted thereinto.

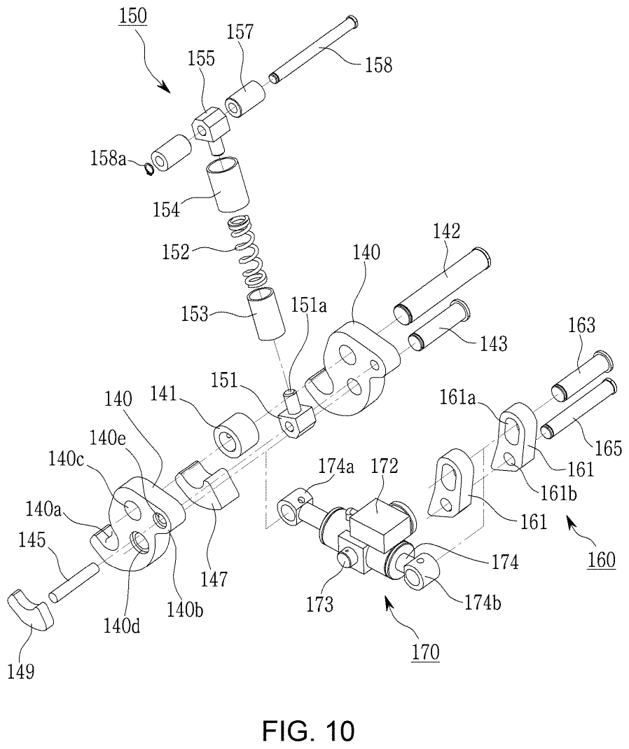

The pivoting hook 140 is pivotably coupled to the internal covers 111, and has the second connection bar 23 removably coupled thereto. As shown in FIG. 10, the pivoting hook 140 may be provided in pair. Each of the pair of pivoting hooks 140 includes a second connection bar coupling recess 140a dented from a lower portion thereof in the opposite direction of the fixing hook 130 and having the second connection bar 23 inserted thereinto.

The fixing hook 130 and the pivoting hook 140 are opened in the opposite directions, and the first connection bar 21 and the second connection bar 23 of the attachment 20 are easily received in the first connection bar coupling recess 131 and the second connection bar coupling recess 140a. A wedge 140b protrudes from an upper portion of the pivoting hook 140 in an oblique direction with respect to the second connection bar coupling recess 140a.

A pivoting shaft coupling hole 140c, a cylinder coupling shaft coupling hole 140d, and a pressing portion coupling shaft coupling hole 140e, spaced apart from one another, penetrate through a plate surface of the pivoting hook 140. The pivoting hook pivoting shaft 142 is inserted into the pivoting shaft coupling hole 140c. Accordingly, the pivoting hook 140 may pivot about the pivoting hook pivoting shaft 142.

A pivoting shaft receiving pipe 141 is disposed between the pivoting shaft coupling holes 140c of the pair of pivoting hooks 140 to maintain a gap between the pair of pivoting hooks 140. The pivoting hook pivoting shaft 142 penetrate through the internal covers 111 and the external covers 115, and then penetrate through the pivoting shaft coupling hole 140c and the pivoting shaft receiving pipe 141 of the pivoting hook 140 and is coupled to the pivoting hook 140. The pivoting hook pivoting shaft 142 is pivotably coupled to the internal covers 111 and the external covers 115 to support the pivoting hook 140 to pivot. Herein, the second connection bar 23 may be coupled to or decoupled from the second connection bar coupling recesses 140a according to a pivoting direction of the pivoting hook 140.

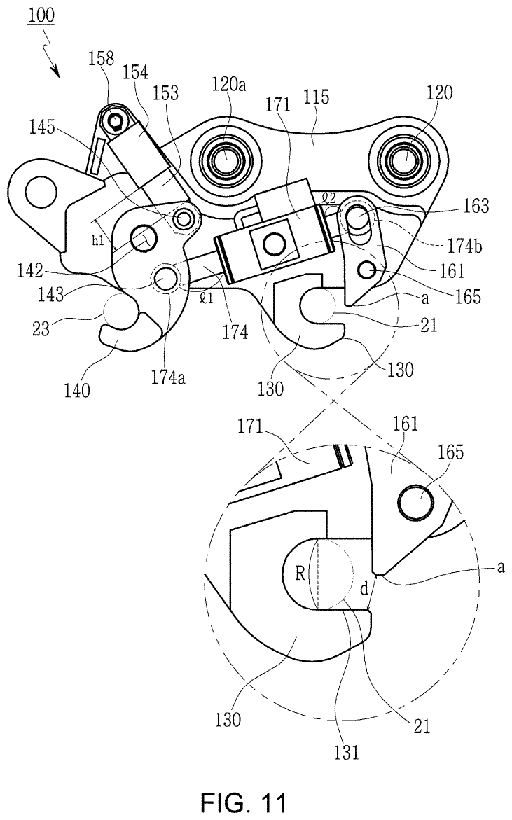

For example, when the pivoting hook 140 is in an upright position as shown in FIG. 11, the second connection bar 23 is coupled to the second connection bar coupling recess 140a.

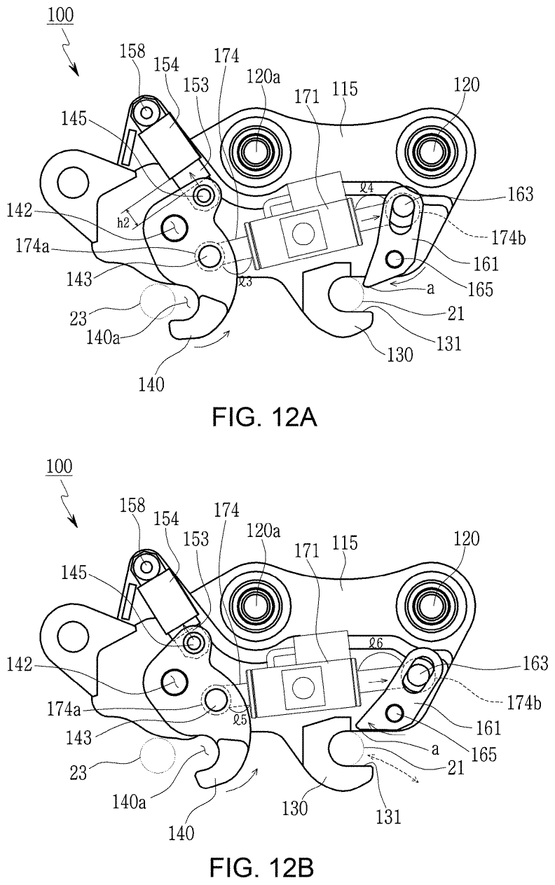

On the other hand, when the pivoting hook 140 in the state of FIG. 11 pivots in the counter clockwise direction as shown in FIG. 12A, the second connection bar coupling recess 140a retreats from the second connection bar 23 and is decoupled therefrom. Since the position of the second connection bar 23 is fixed, the pivoting hook 140 may be coupled to and decoupled from the second connection bar 23 according to a pivoting angle of the pivoting hook 140.

The pivoting angle of the pivoting hook 140 is adjusted by the operating cylinder 170 which will be described below.

The pivoting hook cylinder coupling shaft 143 is coupled to the cylinder coupling shaft coupling hole 140d. The pivoting hook cylinder coupling shaft 143 couples the pivoting hook 140 and the operating cylinder 170 to each other, and allows the pivoting hook 140 to be pivoted by the operation of the operating cylinder 170.

As shown in FIG. 10, a pivoting hook connection pipe 174a of the operating cylinder 170 is disposed to have the same axis as the pivoting hook cylinder coupling shaft 143 of the pair of pivoting hooks 140, and the pivoting hook cylinder coupling shaft 143 penetrates through the pivoting hook connection pipe 174a, and is inserted into the cylinder coupling shaft coupling hole 140d.

Accordingly, when the operating cylinder 170 is operated and the position of the pressing rod 174 is changed, the pivoting hook connection pipe 174a pushes or pulls the pivoting hook cylinder coupling shaft 143, thereby allowing the pivoting hook 140 to pivot.

For example, when the length of the pressing rod 174 between the pivoting hook connection pipe 174a and the operating cylinder body 171 is changed from a first length (l1) shown in FIG. 11 to a third length (l3) shown in FIG. 12A, the pivoting hook connection pipe 174a retreats along with the pressing rod 174 and the pivoting hook 140 is pivoted in the counter clockwise direction.

A pivoting hook pressing portion coupling shaft 145 is coupled to the pressing portion coupling shaft coupling hole 140e. The pivoting hook pressing portion coupling shaft 145 couples the pivoting hook 140 and the pivoting hook elastic pressing portion 150 to each other, and allows the pivoting hook 140 to be always subjected to an elastic force to pivot in the direction of maintaining coupling with the second connection bar 23.

The pressing portion coupling shaft coupling hole 140e penetrates through the wedge 140b of the pivoting hook 140. As shown in FIG. 10, a lower elastic member coupling block 151 of the pivoting hook elastic pressing portion 150 is coaxially disposed between the pressing portion coupling shaft coupling holes 140e of the pair of pivoting hooks 140, and the pivoting hook pressing portion coupling shaft 145 penetrates through the pressing portion coupling shaft coupling holes 140e and the lower elastic member coupling block 151.

A middle pivoting hook extension member 147 and an external pivoting hook extension member 149 are coupled to the pair of pivoting hooks 140. The middle pivoting hook extension member 147 is disposed between the pair of pivoting hooks 140, and the pair of external pivoting hook extension members 149 are disposed on outsides of the pair of pivoting hooks 140.

The pivoting hook extension members 147, 149 are coupled to the outside and the inside of the pivoting hooks 140 to increase the areas of the pivoting hooks 140 and to more stably support the second connection bar 23.

The pivoting hook elastic pressing portion 150 is disposed on the upper portion of the pivoting hooks 140, and applies an elastic force to maintain a coupling state between the pivoting hooks 140 and the second connection bar 23. As shown in FIG. 10, the pivoting hook elastic pressing portion 150 includes the lower elastic member coupling block 151 coupled to the pivoting hook pressing portion coupling shaft 145, an upper elastic member coupling block 155 spaced apart from the lower elastic member coupling block 151, an elastic member 152 having a lower end and an upper end coupled to the lower elastic member coupling block 151 and the upper elastic member coupling block 155, respectively, a lower housing 153 and an upper housing 154 surrounding the outside of the elastic member 152, and a middle cover coupling shaft 158 coupled to the middle covers 113.

The lower elastic member coupling block 151 is pressed toward the pivoting hook pressing portion coupling shaft 145 along with the pair of pivoting hooks 140, thereby transmitting the elastic force of the elastic member 152 to the pivoting hook pressing portion coupling shaft 145. A first protrusion 151a protrudes from an upper portion of the lower elastic member coupling block 151, and is coupled to a lower portion of the elastic member 152.

The upper elastic member coupling block 155 is coupled to the middle cover coupling shaft 158 to fix the position of the upper end of the elastic member 152. A pair of coupling shaft receiving pipes 157 are provided on both sides of the upper elastic member coupling block 155. The pair of coupling shaft receiving pipes 157 serve to maintain the gap between the pair of pivoting hooks 140.

The middle cover coupling shaft 158 penetrates through the upper elastic member coupling block 155 and the pair of coupling shaft receiving pipes 157, and has both ends fixedly coupled to the middle covers 113. Accordingly, the middle cover coupling shaft 158 and the upper elastic member coupling block 155 coupled thereto are fixed in their positions.

A second protrusion 155a protrudes from a lower portion of the upper elastic member coupling block 155, and is coupled to an upper portion of the elastic member 152.

The elastic member 152 is disposed between the upper elastic member coupling block 155 and the lower elastic member coupling block 151, and applies an elastic force in the direction of maintaining a coupling state of the second connection bar 23 to the second connection bar coupling recess 140a.

The lower housing 153 and the upper housing 154 surround the elastic member 152 at a lower portion and an upper portion of the elastic member 152, respectively. The lower housing 153 is formed to be inserted into the upper housing 154.

When the second connection bar 23 is coupled to the pivoting hooks 140 as shown in FIG. 11, the elastic member 152 maintains its initial length, and a distance between the upper housing 154 and the pivoting hook pressing portion coupling shaft 145 maintain a first height h1.

As shown in FIG. 12A, the operating cylinder 170 operates and the pivoting hooks 140 pivot in the counter clockwise direction, and retreat to be spaced apart from the second connection bar 23. In this case, the wedge 140b pivots in the counter clockwise direction, such that the elastic member 152 is compressed, the lower housing 153 is inserted into the upper housing 154, and the distance between the upper housing 154 and the pivoting hook pressing portion coupling shaft 145 is reduced to a second height h2.

In this case, the elastic member 152 is subjected to an elastic force in the direction of allowing the pivoting hooks 140 to pivot in the clockwise direction, that is, the pivoting hooks 140 to be coupled to the second connection bar 23, in order to be stretched to have the initial length.

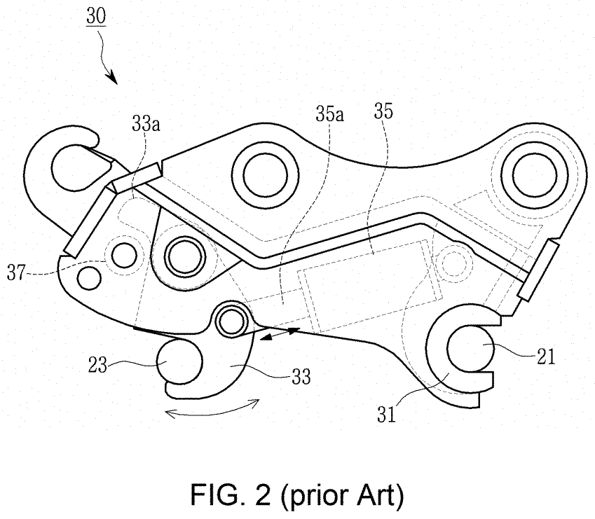

As described above, since the elastic member 152 applies the elastic force in the direction of maintaining the coupling state of the pivoting hooks 140 to the second connection bar 23 in order to return to its initial length, the coupling state of the pivoting hooks 140 to the second connection bar 23 can be maintained by the elastic force of the elastic member 152 even when the operating cylinder 170 malfunctions or a hydraulic pressure is not applied. Accordingly, the second connection bar 23 can be prevented from being dropped down without a safety pin, which is required in the related-art bucket link 30 (see FIG. 2).

The connection bar release prevention lever 160 is pivotably disposed on an upper end of the first connection bar coupling recess 131 of the fixing hook 130 to prevent the first connection bar 21 from being released, as shown in FIGS. 9 and 10.

The connection bar release prevention lever 160 includes a pair of lever bodies 161, a lever pivoting shaft 165 pivotably supporting the pair of lever bodies 161 with respect to the internal covers 111, and a lever cylinder coupling shaft 163 coupled with the operating cylinder 170 to press the lever bodies 161 to be pivoted about the lever pivoting shaft 165.

The pair of lever bodies 161 are formed in a bar shape having a predetermined length, and have lower portions having areas gradually reduced toward the first connection bar coupling recess 131. A coupling shaft coupling slit 161a penetrates through an upper portion of each lever body 161 to allow the lever cylinder coupling shaft 163 to be inserted thereinto, and a pivoting shaft coupling hole 161b penetrates through a lower portion of each lever body 161 to allow the lever pivoting shaft 165 to be inserted thereinto.

Herein, the coupling shaft coupling slit 161a is formed in a long hole shape having a predetermined vertical length. Accordingly, the lever cylinder coupling shaft 163 moves vertically along the coupling shaft coupling slit 161a according to a change in the length of the operating cylinder 170, and the lever bodies 161 pivot about the lever pivoting shaft 165 as shown in FIGS. 12A and 12B.

When the lever bodies 161 pivot about the lever pivoting shaft 165, a distance between a lever end a of a lower portion of each lever body 161 and the first connection bar coupling recess 131 is adjusted, and the first connection bar 21 is prevented from being released. That is, when the first connection bar 21 and the second connection bar 23 are received in the fixing hook 130 and the pivoting hooks 140, respectively, as shown in FIG. 11, a distance d between the lever end a of each lever body 161 and the first connection bar coupling recess 131 is smaller than a diameter R of the first connection bar 21.

Accordingly, the first connection bar 21 is blocked by the lever bodies 161 and is prevented from being released from the first connection bar coupling recess 131.

When the lever bodies 161 pivot in the clockwise direction as shown in 12A, the distance between the lever end a of each lever body 161 and the first connection bar coupling recess 131 is longer than that of FIG. 11, but is still smaller than the diameter R of the first connection bar 21.

Accordingly, the lever bodies 161 may block a release path of the first connection bar 21 and may prevent the first connection bar 21 from being released within a range in which the operating cylinder 170 applies a hydraulic pressure to pivot the pivoting hooks 140.

Accordingly, when the operating cylinder 170 applies a hydraulic pressure during an operation of the excavator, the first connection bar 21 is prevented from being released from the fixing hook 130, such that the attachment can be safely used without an attachment drop accident.

The operating cylinder 170 couples or decouples the pivoting hooks 140 to or from the second connection bar 23 by adjusting the pivoting angle of the pivoting hooks 140, and prevents the first connection bar 21 from being released from the fixing hook 130 by adjusting the distance between the connection bar release prevention lever 160 and the fixing hook 130 by adjusting the pivoting angle of the connection bar release prevention lever 160.

As shown in FIG. 10, the operating cylinder 170 includes the operating cylinder body 171 through which an operating fluid enters or exits, an operating fluid storage 172 disposed on an upper portion of the operating cylinder body 171 to store the operating fluid, a cylinder body fixing shaft 173 fixing the operating cylinder body 171 to the internal covers 111, and the pressing rod 174 inserted across the operating cylinder body 17 and moving in both directions according to the entry/exit of the operating fluid.

The operating cylinder body 171 is fixed to the internal covers 111 by the cylinder body fixing shaft 173. The pressing rod 174 penetrates through and is inserted into the operating cylinder body 171 in the longitudinal direction. A pivoting hook connection pipe 174a is disposed at one end of the pressing rod 174, and a lever connection pipe 174b is disposed at the other end of the pressing rod 174.

The pivoting hook connection pipe 174a is coupled to the pivoting hooks 140 by means of the pivoting hook cylinder coupling shaft 143, and the lever connection pipe 174b is coupled to the lever bodies 161 of the connection bar release prevention lever 160 by means of the lever cylinder coupling shaft 163.

When the operating fluid enters the operating cylinder body 171, the pressing rod 174 moves along the operating cylinder body 171 in the longitudinal direction according to an amount of the entering fluid. In this case, the pressing rod 174 moves along the operating cylinder body 171 in both directions. The pressing rod 174 moves along the operating cylinder body 171 in the horizontal direction with the length being fixed, such that a distance between the pivoting hook cylinder coupling shaft 143 and the operating cylinder body 171, and a distance between the operating cylinder body 171 and the lever cylinder coupling shaft 163 are changed in inverse proportion to each other.

That is, when the distance between the pivoting hook cylinder coupling shaft 143 and the operating cylinder body 171 increases to a first distance l1 as shown in FIG. 11, the distance between the operating cylinder body 171 and the lever cylinder coupling shaft 163 is reduced to a second distance l2.

On the other hand, when the distance between the pivoting hook cylinder coupling shaft 143 and the operating cylinder body 171 is reduced to a third distance 3 by a change in the amount of the operating fluid as shown in FIG. 12A, the distance between the operating cylinder body 171 and the lever cylinder coupling shaft 163 increases to a fourth distance l4. That is, the distance between the operating cylinder body 171 and the lever cylinder coupling shaft 163 increases as long as the reduced distance between the pivoting hook cylinder coupling shaft 143 and the operating cylinder body 171.

The pivoting hooks 140 and the connection bar release prevention lever 160 operate in association with each other by the above-described operation of the operating cylinder 170, and the first connection bar 21 and the second connection bar 23 are prevented from being released.

An operating process of the attachment coupling link 100 having the above-described configuration according to the present disclosure will be described with reference to FIGS. 3 to 12.

The attachment coupling link 100 of the present disclosure is coupled to an end of the arm 11 of the excavator 10 shown in FIG. 1. The pair of boom links 13, 13a are coupled to the pair of boom link coupling shafts 120, 120a, respectively.

In this state, when an operator intends to couple a desired attachment 20 to the attachment coupling link 100, the operator completely drains the operating fluid out of the operating cylinder body 171 as shown in FIG. 12B. Accordingly, when the distance of the pressing rod 174 between the operating cylinder body 171 and the lever cylinder coupling shaft 163 increases to a maximum distance l6, the lever bodies 161 of the connection rod release prevention lever 160 pivot in the clockwise direction and the lever end a is inserted into the internal covers 111.

Accordingly, since the distance between the first connection bar coupling recess 131 and the lever end a is larger than the diameter of the first connection bar 21, the first connection bar 21 can be inserted into the first connection bar coupling recess 131 of the fixing hook 130. In this case, since the pivoting hooks 140 are pulled toward the operating cylinder body 171 by the pressing rod 174, the pivoting hooks 140 retreat from the second connection bar 23.

In this state, the operator supplies the operating fluid to the operating cylinder body 171, and makes the second connection bar 23 seated in the second connection bar coupling recess 140a of the pivoting hooks 140 as shown in FIG. 11. When the pressing rod 174 moves forward to the pivoting hooks 140 to make the second connection bar 23 be inserted into the second connection bar coupling recess 140a, the lever bodies 161 pivot toward first connection bar coupling recess 131 in association with the movement of the pressing rod 174, and the distance d between the first connection bar coupling recess 131 and the lever end a is shorter than the diameter R of first connection bar 21. Accordingly, the lever bodies 161 block a release path of the first connection bar 21, and thus prevents the first connection bar 21 from being released during a work using the attachment 20.

In addition, the elastic member 152 of the pivoting hook elastic pressing portion 150 applies an elastic force in the direction of pushing the pivoting hook pressing portion coupling shaft 145 of the wedge 140b in the clockwise direction, that is, of maintaining the coupling state between the pivoting hooks 140 and the second connection bar 23, and prevents the second connection bar 23 from being released from the pivoting hooks 140.

Accordingly, the first connection bar 21 and the second connection bar 23 of the attachment 20, coupled to the attachment coupling link 100 of the present disclosure, are doubly prevented from being released from the fixing hook 130 and the pivoting hooks 140, respectively, such that a safe work can be performed and a safety accident can be prevented.

When a work with one attachment 20 is completed and the attachment 20 is replaced with another attachment 20, the process is performed in reverse, that is, the operating fluid is completely drained as shown in FIG. 12B, and the lever bodies 161 are spaced apart from the fixing hook 130 and the pivoting hooks 140 retreat from the second connection bar 23, and the fixing hook 130 and the pivoting hooks 140 are decoupled from the first connection bar 21 and the second connection bar 23, respectively.

As described above, in the attachment coupling link according to the present disclosure, the lever bodies of the connection bar release prevention lever block the release path of the first connection bar as long as the operating cylinder applies a hydraulic pressure to maintain the coupling state between the pivoting hooks and the second connection bar, and the first connection bar is prevented from being released.

In addition, the pivoting hook elastic pressing portion is coupled to the pivoting hooks, and the elastic member applies an elastic force in the direction of maintaining a coupling state between the pivoting hooks and the second connection bar, such that the second connection bar is not released from the pivoting hooks even when the operating cylinder is not well operated. Accordingly, a safety accident can be prevented and a safe work can be performed.

In addition, the pair of connection bars and the fixing hook and the pivoting hooks can be stably coupled to each other without using a safety pin which is used in a related-art attachment coupling link for the purpose of safety.

In addition, an operator is not required to pull out a safety pin and to fasten the pin manually, and can attach and detach an attachment and replace the same simply by driving the operating cylinder.

The above-described embodiments of the attachment coupling link of the present disclosure are merely examples, and it will be understood by a person skilled in the art that various changes can be made therefrom and other equivalent embodiments are possible. Therefore, it will be understood that the present disclosure is not limited to the form mentioned in the detailed descriptions. Therefore, the scope of the technical protection of the present disclosure should be defined by the technical concept of the appended claims. In addition, it should be understood that the present disclosure includes the sprits of the present disclosure defined by the appended claims, and all variations, equivalents, and substitutes within the scope of the claims.

What is claimed is:

1. An attachment coupling link for an excavator, comprising:
a cover having a pair of boom link coupling shafts coupled thereto in parallel with each other, the boom link coupling shafts being coupled to boom links of an excavator;
a fixing hook fixedly coupled to a lower end of one side of the cover to have a first connection bar of an attachment removably coupled thereto;
a pivoting hook coupled to a lower end of the other side of the cover to be pivotable about a pivoting hook pivoting shaft, a second connection bar of the attachment being removably coupled to the pivoting hook;
a connection bar release prevention lever pivotably coupled to an upper end of the fixing hook; and
an operating cylinder disposed between the fixing hook and the pivoting hook, the operating cylinder allowing the second connection bar to be mounted in or dismounted from the pivoting hook by adjusting a pivoting angle of the pivoting hook, the operating cylinder preventing the first connection bar from being released from the fixing hook by adjusting a distance between the connection bar release prevention lever and the fixing hook by adjusting a pivoting angle of the connection bar release prevention lever.

2. The attachment coupling link of claim 1, wherein the operating cylinder comprises:
an operating cylinder body fixedly coupled to the cover between the fixing hook and the pivoting hook, and allowing an operating fluid to flow therein; and
a pressing rod inserted into the operating cylinder body in a longitudinal direction, and moving between the fixing hook and the pivoting hook in both directions according an amount of the moved operating fluid.

3. The attachment coupling link of claim 2, wherein the pivoting hook is coupled to one end of the pressing rod by means of a pivoting hook cylinder coupling shaft, and pivots about the pivoting hook pivoting shaft according to a change in a length of the pressing rod between the operating cylinder body and the pivoting hook cylinder coupling shaft, the second connection bar being mounted on or dismounted from the pivoting hook.

4. The attachment coupling link of claim 3, wherein the connection bar release prevention lever comprises:
a pair of lever bodies;
a lever cylinder coupling shaft coupling the pair of lever bodies and the other end of the pressing rod; and
a lever pivoting shaft disposed under the lever cylinder coupling shaft to support the pair of lever bodies to pivot with respect to the cover,
wherein the pair of lever bodies pivot about the lever pivoting shaft according to a change in the length of the pressing rod between the operating cylinder body and the lever cylinder coupling shaft, and a distance between the pair of lever bodies and the fixing hook is adjusted.

5. The attachment coupling link of claim 4, further comprising a pivoting hook elastic pressing portion disposed on an upper portion of the pivoting hook to apply an elastic force to allow the pivoting hook pivoting shaft to pivot in a direction of maintaining a coupling state between the pivoting hook and the second connection bar.

6. The attachment coupling link of claim 5, wherein a second connection bar coupling recess is dented on a lower portion of the pivoting hook to have the second connection bar inserted thereinto,
wherein a wedge extends outward from an upper portion of the pivoting hook to be opposite the second connection bar coupling recess, and
wherein the pivoting hook elastic pressing portion comprises:
a lower elastic member coupling block coupled to the wedge;
an upper elastic member coupling block spaced apart from the lower elastic member coupling block;
a middle cover coupling shaft penetrating through the upper elastic member coupling block to be coupled to the cover; and
an elastic member coupled between the lower elastic member coupling block and the upper elastic member coupling block to apply an elastic force to the wedge.
